(19) United States
(12) Patent Application Publication
(10) Pub. No.: US 2003/0139271 A1
(43) Pub. Date: Jul. 24, 2003

(54) Inflatable bag with closure and method of providing the same

(76) Inventors: Erling Vangedal-Nielsen, Vedbaek (DK); Kim Gylle Petersen, Karlslunde (DK)

Correspondence Address: Klein, O'Neill & Singh, 2 Park Plaza, Irvine, CA, 92614, US

(21) Appl. No.: 10/339,162

(22) Filed: Jan. 7, 2003

Related U.S. Application Data
(63) Continuation of application No. PCT/DK01/00461, filed on Jul. 2, 2001.

(30) Foreign Application Priority Data
Jul. 7, 2000 (EP) 00610071.3

(51) Int. Cl. B31B 3/00

(52) U.S. Cl. 493/162

(57) ABSTRACT

An inflatable bag (10) for packaging and protecting an object (70) received within the bag, comprises a web of a foil material defining an elongated configuration having a first set of opposite parallel edges (33, 35). The web is folded into a four-ply assembly (12; 14; 16; 18) folded transversely relative to the edges (33, 35) and defining four foil layers of substantially identical shape, A first and a second foil layer (12; 14) of the assembly are joint to one another by a first set of joints extending substantially parallel with said edges and defining a first chamber (I). The second foil layer (14) and a third foil layer (16) of the assembly are interconnected through a first fold (20) and joint to one another by a second set of joints extending substantially parallel with the edges and defining a second chamber (II). The third foil layer (16) and a fourth foil layer (18) of the assembly are joint to one another by a third set of joints extending substantially parallel with said edges and defining a third chamber (III).The second chamber (II) constitutes an inner chamber communicating with the environment through a first opening opposite the first fold (20) for allowing the object (70) to be introduced into the inner chamber through the first opening (20). The first and third chambers (I; III) communicate with one another through a passage delimited by the first fold (20) and a second fold (22) interconnecting the fourth foil layer (18) and the first (12) or the second foil layer (14) and further communicate with the environment through a closable and sealable, second opening for allowing an inflation medium to be introduced into the first and third chambers (I; III) through the closable and sealable, second opening (FIGS. 1 and 6a, 6b).

The present invention relates to a method of producing an inflatable bag for packaging and protecting an object received within the bag, an inflatable bag for packaging and protecting the object received within the bag, and further a closure of an inflatable bag. Within the technical field of packaging, a particular technique relating to packaging fragile or costly products in air-inflatable and deflatable packages is known, which technique is described in, among others, EP 0 306 204, DE 4007128, FR 2747108, WO98/51585, U.S. Pat. Nos. 4,155,453, 4,465,188, 4,874,093, 4,882,558, 4,918,904, 4,949,530, 5,263,587, 5,272,856, 5,427,830, 5,588,532, 5,692,833 and 5,769,231. Reference is made to the above patent applications and patents and the above patents are further hereby incorporated in the present specification by reference.

Packaging and shipping fragile products and particularly fragile and costly products such as electronic components or electronic apparatuses, medical samples or medical products, surgical instruments, spare parts, toys, household products including mechanical or electrical or electronic utensils etc. has been used for decades and has mostly involved the utilization of lightweight foamed shells or elements in which the product or object to be packaged and shipped is kept stationary within a shielding envelope of foamed shells or foamed elements.

The above-mentioned patent applications and patents relate to an improvement in relation to the utilization of foamed protective articles as inflatable bags for packaging and shipping fragile products or objects, such as the products or objects mentioned above, reduces radically the gross weight of the package including the protective bag and the product as compared to a similar assembly including foamed elements and the product or object to be protected by the foamed articles. Apart from reducing the overall weight of the assembly including the protective inflatable bag and the product or object to be protected as compared to the above-described prior art technique including foamed protective elements, the technique of utilizing an inflatable bag further provides the advantage of allowing, on the one hand, the inflatable bag to be utilized for different products and on the other hand allows for easy packaging of the object or product to be protected.

The commercially available inflatable bags including the bags described in the above-listed patent applications and patents, however, suffer from severe drawbags in relation to the complexity of the structure of the bags and in consequence necessitates the utilization of fairly complex and elaborated production techniques involving separate and distinct assembling processes and the combination of a number of individual components to be assembled into the inflatable bag.

An object of the present invention is to provide a refined and improved technique of producing inflatable bags for packaging purposes and for packaging fragile and costly products and in doing so protecting the products during transportation or shipment. In particular, the present invention provides the distinct advantage as compared to the prior art methods of producing inflatable bags of providing a complete inflatable bag from a single foil without the necessity of utilizing additional separate components for closure or sealing purposes and in consequence simplifying the assembling technique and the technique of producing the bags.

A further advantage of the present invention as compared to the prior art inflatable bags relates to the improved reliability of the inflatable bag as compared to the prior art multiple component bags, as the simplified inflatable bag according to the second aspect of the present invention and produced in accordance with the method according to the first aspect of the present invention, due to a reduced number of components, is contemplated to be exposed to a reduced failure rate as compared to the more complex multicomponent prior art inflatable bags.

A particular feature of the present invention relates to the fact that the method of producing the inflatable bag according to the second aspect of the present invention and produced in accordance with the method according to the first aspect of the present invention allows the inflatable bag to be produced in a continuous or intermittent process from a single continuous band of foil material.

The above object, the above advantage and the above feature together with numerous other objects, advantages and features which will be evident from the below detailed description of preferred embodiments of the bag according to the second aspect of the present invention and produced in accordance with the method according to the first aspect of the present invention are, according to a first aspect of the present invention obtained by a method of producing an inflatable bag for packaging and protecting an object received within said bag, comprising: A method of producing an inflatable bag for packaging and protecting an object received within the bag, comprising:

i) providing a continuous band of a foil material,

ii) moving said band in the longitudinal direction of the band,

iii) folding said band parallel to the longitudinal direction of the band into a four-ply assembly defining four foil layers of substantially identical shape,

iv) joining a first and a second foil layer of said assembly to one another by a first set of joints extending substantially transversely relative to the longitudinal direction of said band,

v) joining said second foil layer and a third foil layer of said assembly being interconnected through a first fold by a second set of joints extending substantially transversely relative to the longitudinal direction of said band,

vi) joining said third foil layer and a fourth foil layer of said assembly to one another by a third set of joints extending substantially transversely relative to the longitudinal direction of said band,

vii) separating a segment of said four-ply assembly delimited by said sets of joints, thereby providing said inflatable bag having a first chamber defined between said first and second foil layers, a second chamber defined between said second and third foil layer and a third chamber defined between said third and fourth foil layer, said bag further having an inner chamber constituted by said second chamber, and communicating with the environment through a first opening opposite said first fold for allowing the object to be introduced into the inner chamber through the first opening, and said first and third chambers communicating with one another through a passage delimited by said first fold and a second fold interconnecting said first foil layer and said first or second foil layer and further communicating with the environment through a closable and sealable second opening for allowing an inflation medium to be introduced into said first and third chamber through said closable and sealable, second opening. The above object, the above advantage and the above feature together with numerous other objects, advantages and features which will be evident from the below detailed description of preferred embodiments of the bag according to the second aspect of the present invention and produced in accordance with the method according to the first aspect of the present invention are, according to a second aspect of the present invention obtained by an inflatable bag for packaging and protecting an object received within said bag and produced in accordance with a method according to the first aspect of the present invention, comprising: An inflatable bag for packaging and protecting an object received within said bag and produced in accordance with the method according to claim 1, comprising:

a web of a foil material, said web defining an elongated configuration having a first set of opposite parallel edges,

said web being folded into a four-ply assembly folded transversely relative to said edges and defining four foil layers of substantially identical shape,

a first and a second foil layer of said assembly being joint to one another by a first set of joints extending substantially parallel with said edges and defining a first chamber,

said second foil layer and a third foil layer of said assembly being interconnected through a first fold and joint to one another by a second set of joints extending substantially parallel with said edges and defining a second chamber,

said third foil layer and a fourth foil layer of said assembly being joint to one another by a third set of joints extending substantially parallel with said edges and defining a third chamber,

said second chamber constituting an inner chamber communicating with the environment through a first opening opposite said first fold for allowing said object to be introduced into said inner chamber through said first opening, and

said first and third chambers communicating with one another through a passage delimited by said first fold and a second fold interconnecting said fourth foil layer and said first or said second foil layer and further communicating with the environment through a closable and sealable, second opening for allowing an inflation medium to be introduced into said first and third chambers through said closable and sealable, second opening.

According to the basic teachings of the present invention, the inflatable bag, according to the second aspect of the present invention and produced in accordance with the method according to the first aspect of the present invention, is produced from a single web of a foil material, which web is folded into a four-ply assembly providing three chambers including an inner chamber sandwich between two outer chambers communicating with one another through a passage delimited by the fold connecting the walls of the inner chamber together.

In the folded four-ply assembly, the inner chamber communicates with the environment through an opening opposite the passage establishing communication with the outer chambers sandwiching the inner chamber communicating with the environments through a closable and sealable opening for allowing the inflation medium to be introduced into the first and third chambers or according to the above description the outer chambers. The inflation medium may in most instances simply be pressurized air or alternatively be a gas or liquid, such as a low or high molecular weight gas e.g. a non-combustible and substantially inert gas, such as nitrogen, carbon dioxide, helium or any other low cost gas or alternatively a liquid, such as plain water.

Provided water is used as the inflation medium, the inflatable bag according to the second aspect of the present invention and produced in accordance with the method according to the first aspect of the present invention may in particular be used for the additional purpose of maintaining the object received within the bag at a low temperature such as a temperature below the freezing point of water, e.g. for the purpose of maintaining a biological sample being a solid or liquid sample at a stable low temperature preventing the sample from being degraded due to the influence from bacteria or simply heat.

The material used for the web of the four-ply assembly has, dependent on the actual application and also the inflation medium used, to comply with certain requirements as to mechanical strength, flexibility, elasticity and also permeability to the air and further the inflation medium. Preferably, the web is made from an integral continuous web of a plastics material substantially impermeable to liquid and/or gas.

Although the inflatable bag, according to the second aspect of the present invention and produced in accordance with the method according to the first aspect of the present invention, is preferably made from a single continuous band or web of a plastics material or any other relevant material such as a metal foil, e.g. aluminium foil or a combined plastics material and aluminium foil, the web which is folded into the four-ply assembly of the inflatable bag may alternatively be composed of two, three or four foil layer sheets constituting respective foil layers of the web and made from a plastics material substantially impermeable to liquid and/or gas.

In the present context, the term bag is to be construed a generic term representing any element of a type allowing the element to be used for encircling a product like a bag, however, the term is by no means to be construed limiting the geometrical configuration of the element in question, as the element may have any configuration differing from the conventional understanding of the term or expression bag such as the configuration of a map, a flat foldable element of an elongated configuration to a high degree having resemblance to a hose or similar structure or a differently configurated element.

The closable and sealable, second opening may be established in any appropriate manner by utilizing specific and dedicated means for allowing the second opening to be sealed or closed, e.g. by means of a weld, an adhesive, a separate closure clamp or similar element after the inflation medium has been introduced into the first and third chambers. According to two advantageously embodiments of the bag according to the second aspect of the present invention and produced in accordance with the method according to the first aspect of the present invention, the sealable second opening is established in accordance with a self-closure technique well known within the art of freezing mould bags, e.g described in EP 0 264 407, EP 0 574 496, EP 0 616 948 and EP 0 825 122 to which patent applications and patents reference is made or alternatively according to a closure technique including the technique described in RE 31890 to which reference is made and which U.S. patent is hereby further incorporated in the present specification by reference. According to the first embodiment, the closable and sealable, second opening is constituted by prolongations of the fourth foil layer and the first or the second foil layer, which prolongations define turned-in parts extending into the first or third chamber and being joined together for providing two closure pockets for establishing a self-closure valve at the closable and sealable, second opening. According to a further refinement of the self-closure valve technique utilized in the above described first advantageous embodiment of the bag according to the second aspect of the present invention and produced in accordance with the method according to the first aspect of the present invention, which refinement constitutes a particular and distinct aspect of the present invention, the turned-in parts of the prolongations or extensions are joined together by additional joints for permanently maintaining the turned-in parts of the prolongations or extensions in a face-to-face and non-folded state. The additional joints may be constituted by a single joint connecting the one or both turned-in foil parts to one of the foil layers of which the turned-in parts constitute prolongations or extensions. The above-mentioned joint may be constituted by a point or circular weld or similar connection or joint and furthermore, the turned-in parts may preferably be joined together by additional joints joining the turned-in parts together without joining the turned-in parts to the adjacent foil layers which additional joints connecting the turned-in parts together may be configurated as linear joints, bent, curved or any other appropriately configurated joints.

According to the above-described alternative embodiment having a knot-closure, the fourth foil layer and the first or the second foil layer defining prolongations or extensions are provided with perforations or cuttings defining flaps of the prolongations or extensions for allowing the flaps to be tied together for providing a closure knot for closing off the closable and sealable, second opening.

For establishing a permanent and reliable sealing of the closable and sealable, second opening through the use of a closure knot, an additional material such as an adhesive may appropriately be used in connection with a closure knot as the adhesive is applied between the two prolongations or extensions prior to the tying of the knot thereby glueing or adhering the material of the closure knot together.

According to further alternative embodiments of the inflatable bag according to the second aspect of the present invention and produced in accordance with the method according to the first aspect of the present invention, the first set of joints are coextensive with and joined to the third set of joints, and further alternatively the second set of joints are coextensive with and joined to the first and/or the third set of joints. According to these alternative embodiments, the chambers being the first, the second and the third chambers may be delimited by a single set of joints or alternatively separate set of joints.

The second chamber constituting the inner chamber in which the object or product to be protected within the inflatable bag is received, may constitute a single chamber having a configuration preferably corresponding to the configuration or shape of the product or object to be received within the inner chamber. For maintaining the object or product in a specific orientation and position within the inner chamber of the bag, the second chamber or inner chamber is preferably further delimited by further joints interconnecting the second and third foil layers. Alternatively or additionally, the inner chamber may be separated into two or more separate chambers or compartments by additional joints for providing separate objects receiving compartments within the inflatable bag such as an inner chamber communicating with an adjacent chamber constituting a part of the second chamber and delimited relative to the inner chamber by a restriction.

For allowing the passage of the inflation medium from the first chamber to the third chamber or vice versa, the first and third chambers may further, according to another embodiment of the inflatable bag according to the second aspect of the present invention and produced in accordance with the method according to the first aspect of the present invention, be interconnected through perforations or holes in the second and third foil layers.

The technique utilized for establishing the joints may, dependent on the material used for the foil material, be welded joints or joints established by means of a glue or an adhesive material or a combination of welded and glued joints.

The material used for the foil material may, as stated above, be any appropriate material exhibiting adequate properties as to permeability and strength and are further preferably plastics material such as polyethylene, preferably LDPE or HDPE or any other glueable or weldable foil material, preferably plastics or polymer foil material or aluminium foil material or combinations of such foil materials.

The configuration of the inflatable bag according to the second aspect of the present invention and produced in accordance with the method according to the first aspect of the present invention being established through the folding of the web into a four-ply structure defining two outer chambers and an inner chamber may be modified through the provision of additional outer or alternatively inner chambers. Thus, according to a further embodiment of the inflatable bag according to the second aspect of the present invention and produced in accordance with the method according to the first aspect of the present invention, the web defines additional sets of foil layers, each of the additional set of foil layers defining an additional inner chamber or alternatively an additional outer chamber.

The inflatable bag according to the second aspect of the present invention and produced in accordance with the method according t o the first aspect of the present invention may, as stated above, have any appropriate configurations, such as a square, a circular, an elliptical, a polygonal or any other geometrical shape, however, according to the presently preferred embodiment of the inflatable bag according to the second aspect of the present invention and produced in accordance with the method according to the first aspect of the present invention, the foil layers have rectangular configurations.

The above object, the above advantage and the features together with numerous other objects, advantages and features which will be evident from the below detailed description of preferred embodiments of the bag according to the second aspect of the present invention and produced in accordance with the method according to the first aspect of the present invention, are, according to a third aspect of the present invention obtained by a closure of an inflatable bag, comprising:

two foil layers of substantial identical shape and constituting at least part of a pair of walls of the bag, the bag defining an inner space delimited by the pair of walls being joined together by a peripheral joint except for a peripheral area constituting an inlet opening including the closure,

the foil layers having at the inlet opening foil prolongations or extensions defining turned-in parts extending from the inlet opening into the inner space of the bag and defining from the inlet opening a longitudinal extension of the turned-in flaps into the inner space, the turned-in parts defining two closure pockets being open towards the inner space of the bag,

a first set of joints extending from the peripheral joint at the inlet transversely to the longitudinal direction, the first set of joints joining the foil layers and the prolongations or extensions together at a position along the longitudinal extension, the first set of joints defining a pair of opposite joint ends delimiting the width of the inlet opening,

a second set of joints joining the prolongations or extensions defining the turned-in parts together without joining the prolongations or extensions to the two foil layers and extending from the joint ends towards the inner space of the bag, the second set of joints defining an inlet channel extending from the inlet opening into the inner space of the bag, and

at least one further dot-shaped joint joining the turned-in parts to one of the foil layers for maintaining the turned-in parts in parallel and stretched relationship when the closure pockets are filled with an inflation medium and pressurized as the bag be inflated.

The closure according to the third aspect of the present invention is characterized by a combination of two distinct features, namely firstly, the provision of the second set of joints joining the turned-in parts of the closure together and the at least one dot-shaped joint linking the turned-in parts to one of the two foil layers of the foil layers of the closure. The second set of joints defines the inlet channel extending from the joint ends of the first set of joints between the turned-in parts of the two foil layers, which inlet channel is to be closed off as the two closure pockets be expanded for pressing the foil materials of the inlet channel together preventing the inflatable medium being pressurized gas or any other fluid from leaking from the inner space of the bag through the inlet channel. A single dot-shaped joint may be provided or alternatively two or more dot-shaped joints or a set of dot-shaped joints may be provided.

For ensuring that the pressurized fluid is not leaking through the inlet channel between the two turned-in foil layers, the foil layer material within the inlet channel is to be kept in a parallel and stretched mode, which is established through the provision of the dot-shaped joint which links the two turned-in parts of the foil layers to one of the two foil layers, thereby causing the foil layer materials to be maintained in a specific an stretched position and further being stretched as the closure pockets be expanded by the inflation medium or liquid.

From the technical field of freezing mold bags or ice cube bags, self-closure valves are known, such as the self-closure valves illustrated and described in EP 0 129 072, and in the above-mentioned patents EP 0 246 407 and EP 0 574 496 to which reference is made. None of the prior art self-closure valves of ice-cube bags, however, describe the provision of the inlet channel defined by a set of joints joining the turned-in valve flaps or foil layers together and a separate joint linking the turned-in parts to one of the two outer walls of the bag exclusively.

The inventors of the closure according to the third aspect of the present invention, have through extensive experiments tested the prior art self-closure valves of ice-cube bags for gas-inflatable bag closures and have through these experiments realized that the prior art ice-cube closure valves which may provide a self-closure of a freezing mold bag are by no means adequate and safe for the closure of a gas-inflated packaging bag, such as the inflatable bag according to the second aspect of the present invention and produced in accordance with the method according to the first aspect of the present invention. The provision of the above-described combination of the second set of joints joining the turned-in parts together and the dot-shaped joint linking the turned-in parts to one of the foils of the closure, have, surprisingly, proven to provide a safe and reliable closure, the failure rate of which is very close to 0%, as the closure has proven to prevent the inflatable bag from leaking the inflation medium, such as gas through the inlet channel.

According to alternative embodiments of the closure according to the third aspect of the present invention, the closure may constitute a separate or constitute an integral part of the bag as the two foil layers may constitute two separate foil layers of the bag or alternatively constitute integral parts of the pair of walls of the bag, the bag being a bag having a single inner chamber, a bag having two or more inner chambers defined by separate partition walls constituted by separate foil layers or constituted by folded foil parts of the walls of the bag.

The inlet to the closure according to the third aspect of the present invention may, according to a first embodiment, be established between the two joint ends defined by the first set of joints. For allowing the closure to be used for manual usage or alternatively automatised packaging and/or filling, the first set of joints, however, are preferably provided with extensions. Consequently, the first set of joints preferably have joint extensions extending outwardly from the joint ends and defining a converging, diverging or straight extension of the inlet channel.

The second set of joints which, as stated above, are characteristic of the closure according to the third aspect of the present invention may, according to alternative embodiments, be constituted by linear joints, curved joints, combined linear, bend and/or curved joints, and may define a diverging, converging or tubular inlet channel or a combined diverging, converging and/or straight inlet channel.

The dot-shaped joint which is, as stated above, characteristic of the closure according to the third aspect of the present invention may, in accordance with alternative embodiments be configurated as a circular, an eliptical, a square, a rectangular, a polygonal or any other configurated joint or a combination of any of the above joints or being composed of a plurality of individual microjoints.

The closure may, as discussed above, be constituted by a separate component or constitute an integral part of the bag, similarly, the extensions of the two foil layers defining the turned-in parts for defining the closure pockets may, according to alternative embodiments, be constituted by separate foil layers as the prolongations or extensions may be constituted by integral parts of the two foil layers or be constituted by separate foil layer parts joined to the two foil layers.

The closure according to the third aspect of the present invention may be implemented as a separate component of the bag or as an integral part of the bag, which bag may further have any of the features of the bag according to the second aspect of the present invention and produced in accordance with the method according to the first aspect of the present invention.

The bag according to the second aspect of the present invention and produced in accordance with the method according to the first aspect of the present invention and also the closure according to the third aspect of the present invention may be dependent of the application and in this context particularly the lifetime of the bag defined as the period of time through which the bag being inflated with an inflation medium, such as pressurized gas, is maintained in its pressurized state for fulfilling its intentional purpose as a packaging and protection bag, be selected from single layer polymer materials, such as PP, PVC, PV or PE materials being LD, PE, HDPE or MDPE of a thickness varying from 10 μm-100 μm or coextruded or laminated polymer foils exhibiting improved gas impermeability properties as compared to single layer PE foil layers. The combined, the co-extruded or laminated polymer layers may, apart from PE, include PP, PVC and PU materials. Preferably, the laminated polymer layers include three or more layers exhibiting identical outer layers, such as PE layers sandwiching an intermediate layer or intermediate layers of another material or other materials.

The present invention is now to be further described with reference to the drawings, in which:

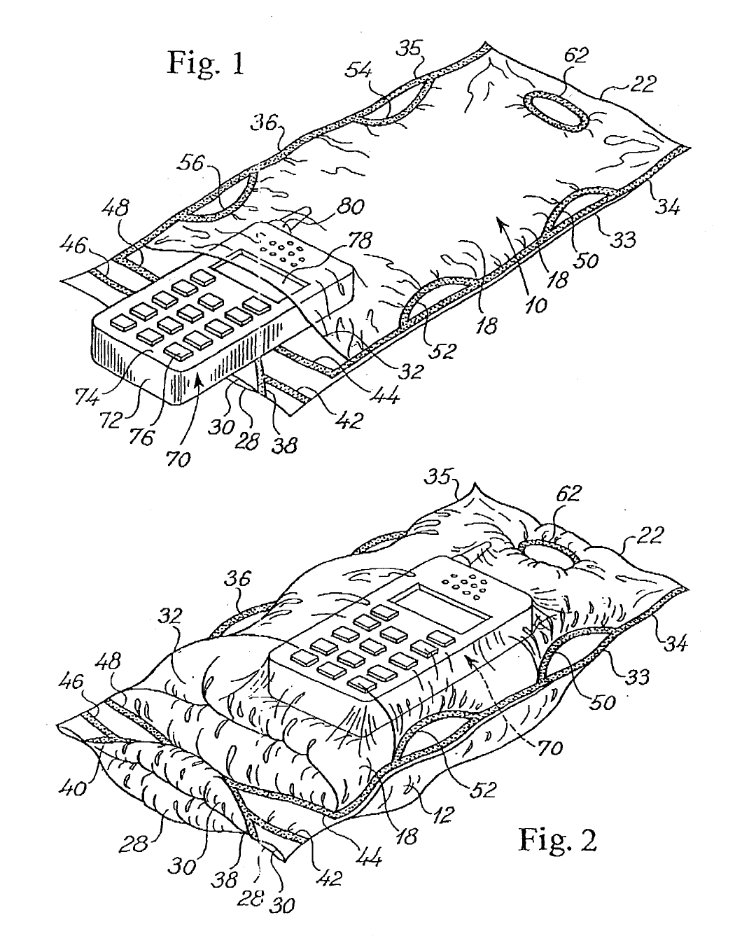

FIG. 1 is a schematic and perspective view of a first side or the upper side of a first and presently preferred embodiment of an inflatable bag for packaging and protecting a n object being a mobile or cellular telephone which is introduced into the bag through an opening thereof,

FIG. 2 is a schematic and perspective view similar to the view of FIG. 1 illustrating the first and presently preferred embodiment of the inflatable bag having the object being a mobile telephone received within the bag and after inflation of the bag,

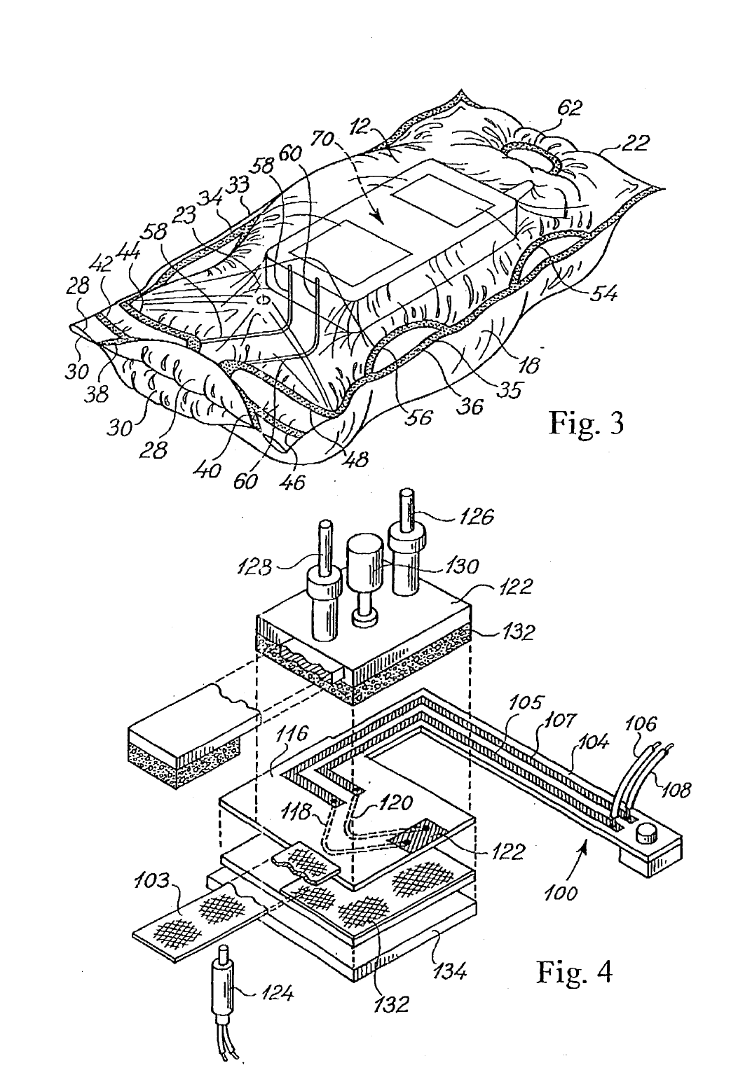

FIG. 3 is a schematic and perspective view similar to the views of FIGS. 1 and 2 illustrating the inflated bag also shown in FIG. 2 from the opposite side or the lower side,

FIG. 4 is a schematic and perspective view of a detail of certain tools for the online production of inner weld seams within the inflatable bag,

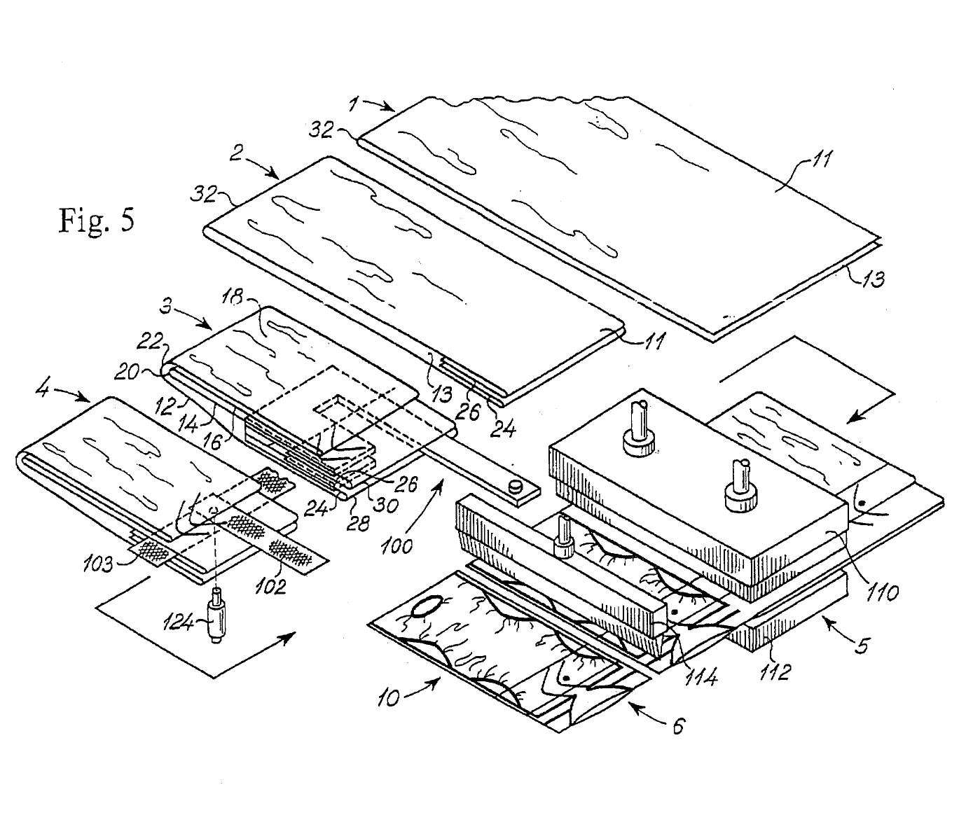

FIG. 5 is a schematic and perspective view illustrating a presently preferred method of producing the inflatable bag according to the second aspect of the present invention and produced in accordance with the method according to the first aspect of the present invention,

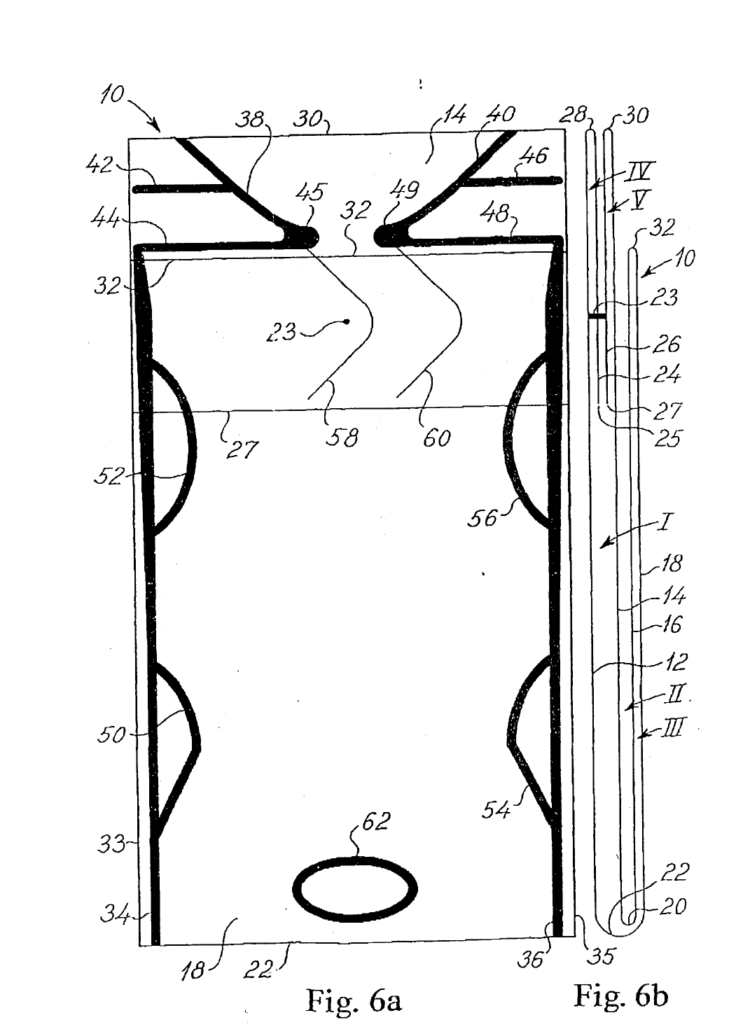

FIGS. 6a and 6b are schematic elevational and side-sectional views, respectively, of the first and presently preferred embodiment of the inflatable bag according to the second aspect of the present invention and produced in accordance with the method according to the first aspect of the present invention, also shown in FIGS. 1-3,

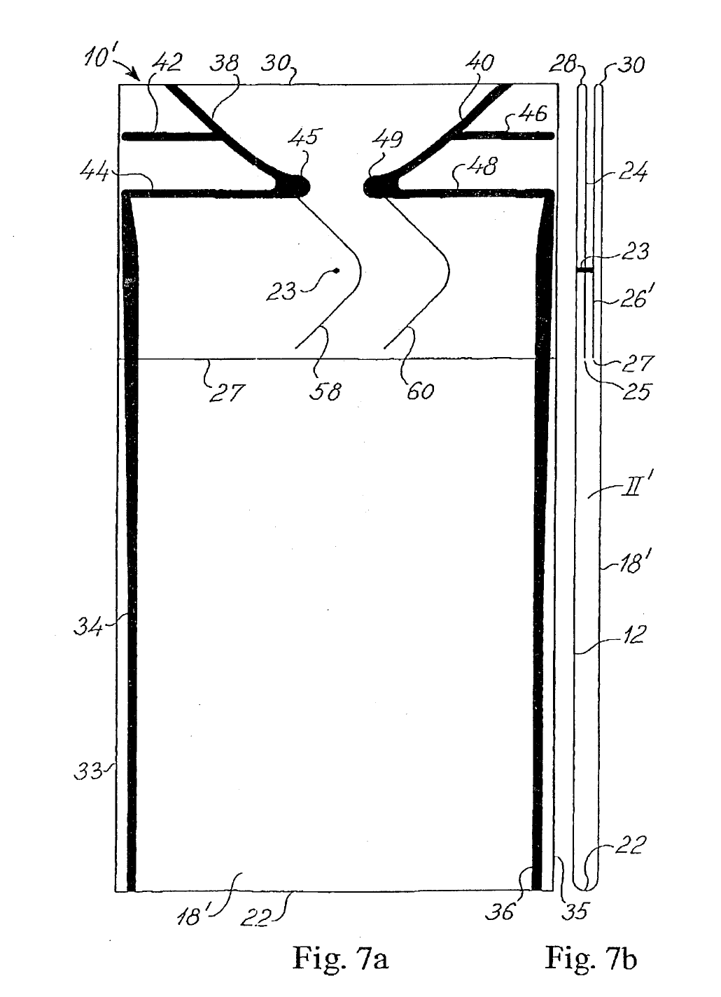

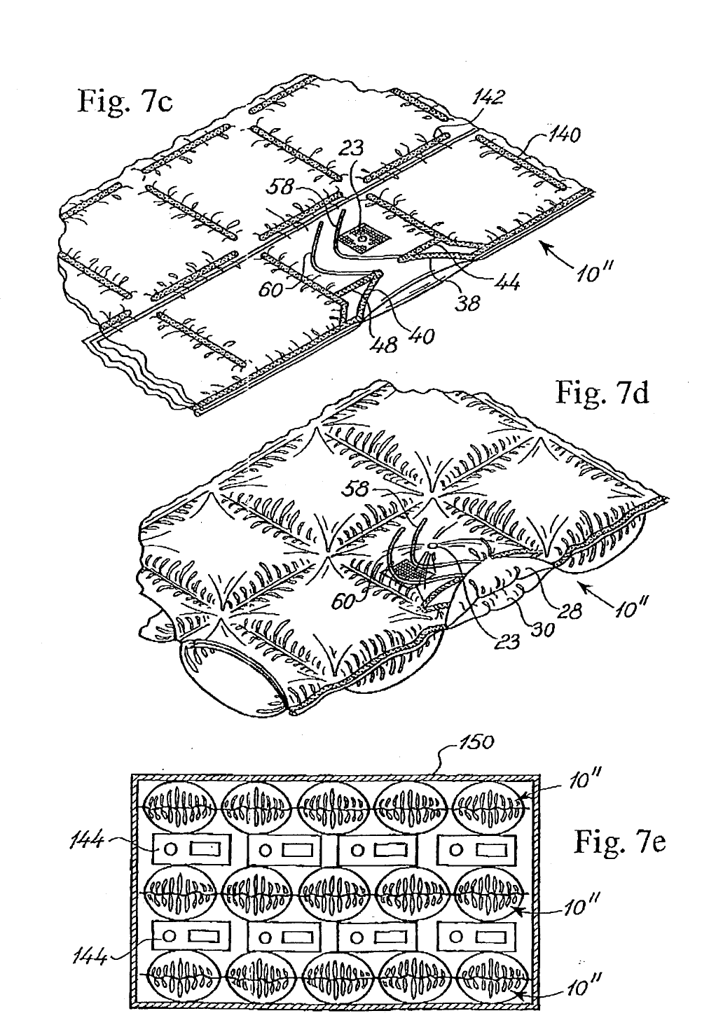

FIGS. 7a and 7b are schematic elevational and side-sectional views, respectively, of the second embodiment of the inflatable bag according to the second aspect of the present invention and produced in accordance with the method according to the first aspect of the present invention,

FIGS. 7c and 7d are schematic and sectional views of a modified version of the second embodiment of the inflatable bag according to the second aspect of the present invention and produced in accordance with the method according to the first aspect of the present invention, in a non-inflated and an inflated state, respectively,

FIG. 7e is a sectional view illustrating the usage of the modified second embodiment of the inflatable bag according to the second aspect of the present invention and produced in accordance with the method according to the first aspect of the present invention also shown in FIGS. 7c and 7d,

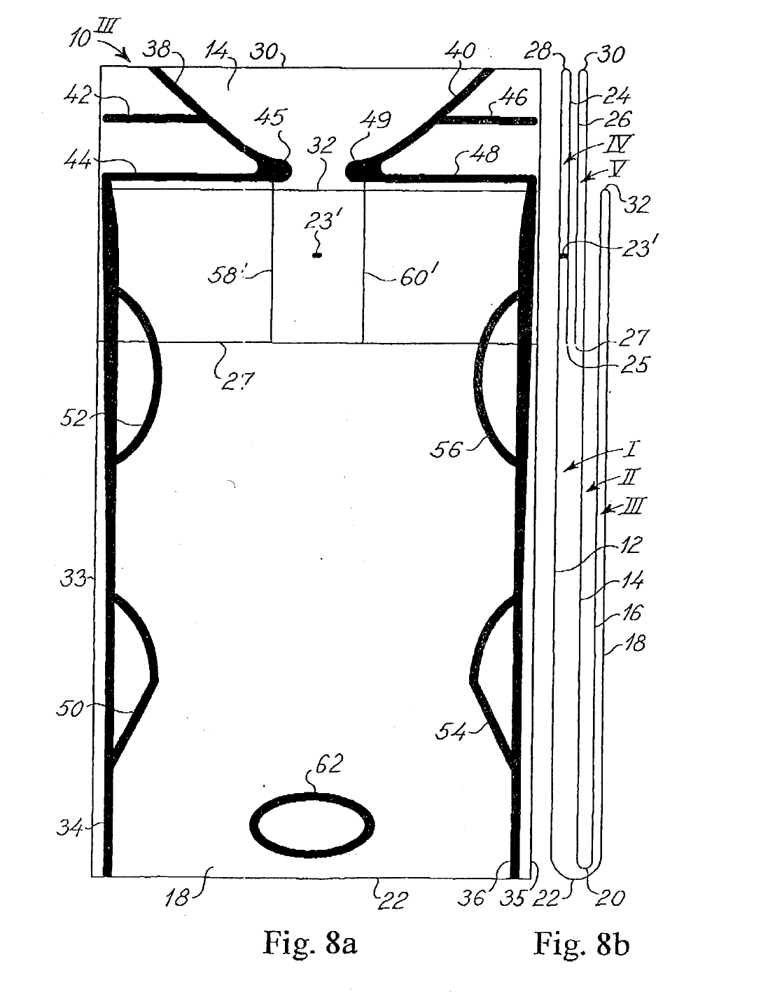

FIGS. 8a and 8b are schematic elevational and side-sectional views, respectively, of the third embodiment of the inflatable bag according to the second aspect of the present invention and produced in accordance with the method according to the first aspect of the present invention,

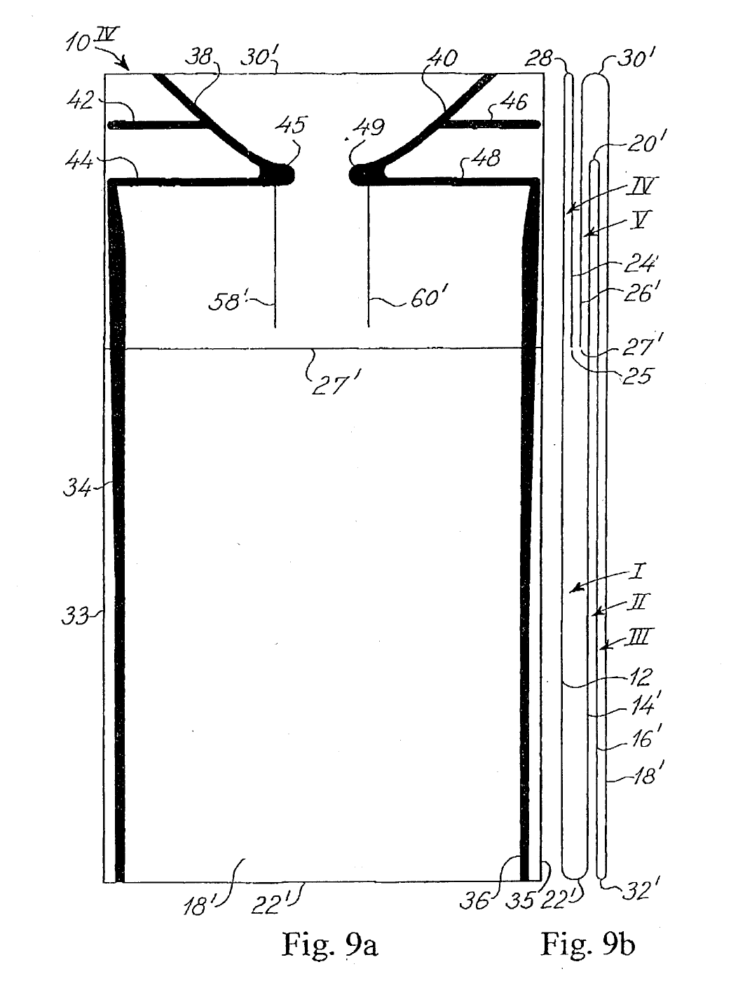

FIGS. 9a and 9b are schematic elevational and side-sectional views, respectively, of the fourth embodiment of the inflatable bag according to the second aspect of the present invention and produced in accordance with the method according to the first aspect of the present invention,

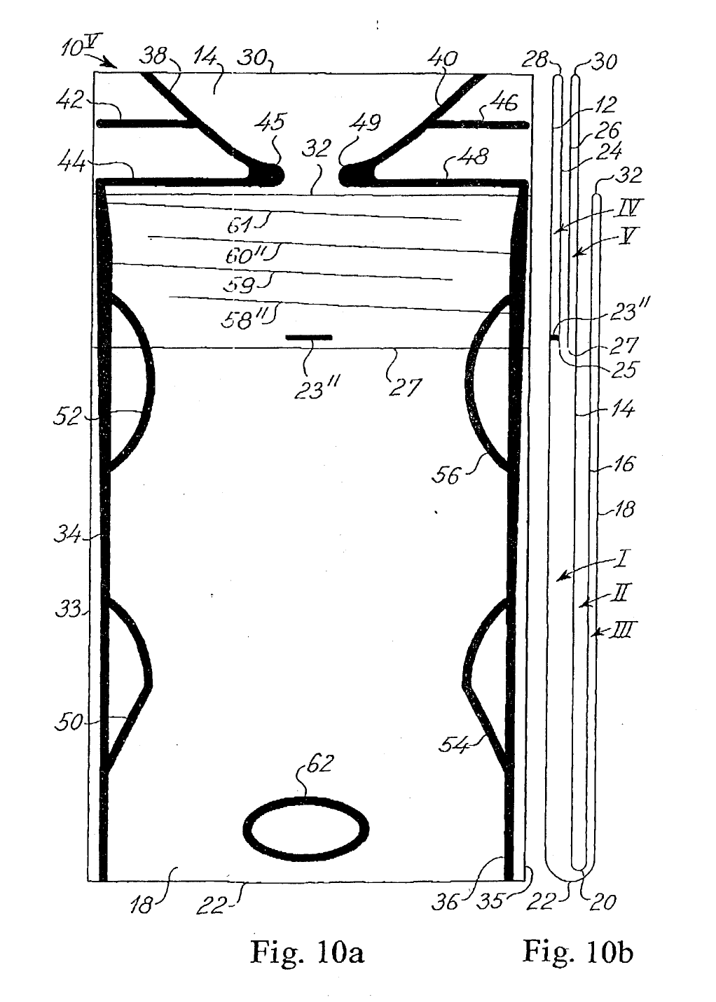

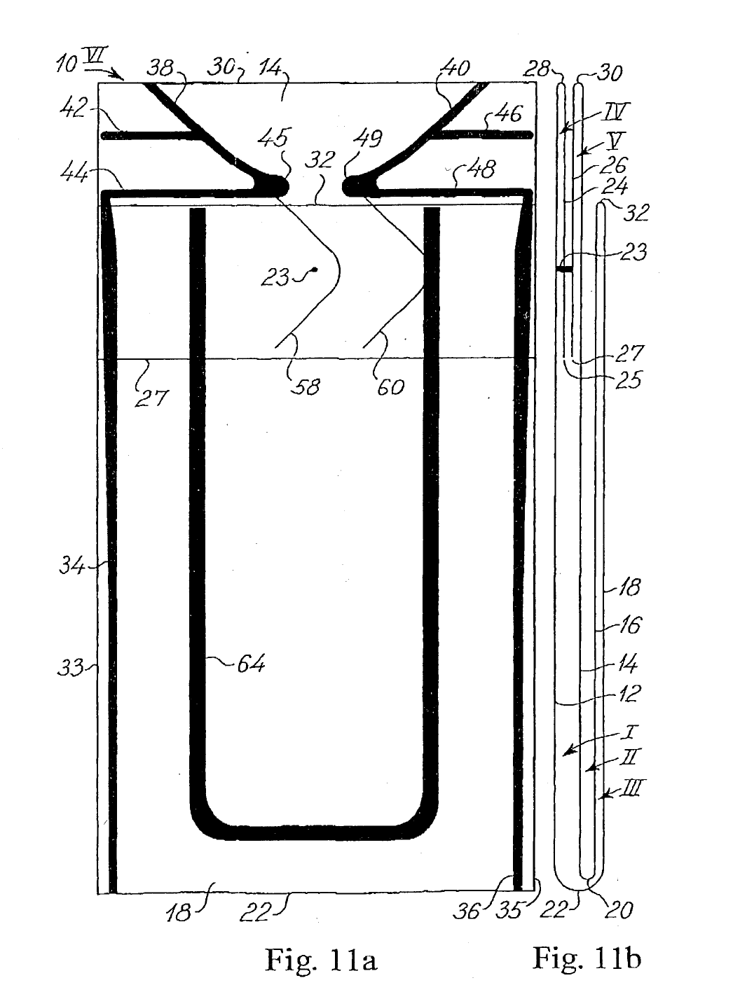

FIGS. 10a and 10b are schematic elevational and side-sectional views, respectively, of the fifth embodiment of the inflatable bag according to the second aspect of the present invention and produced in accordance with the method according to the first aspect of the present invention,

FIGS. 11a and 11b are schematic elevational and side-sectional views, respectively, of the sixth embodiment of the inflatable bag according to the second aspect of the present invention and produced in accordance with the method according to the first aspect of the present invention,

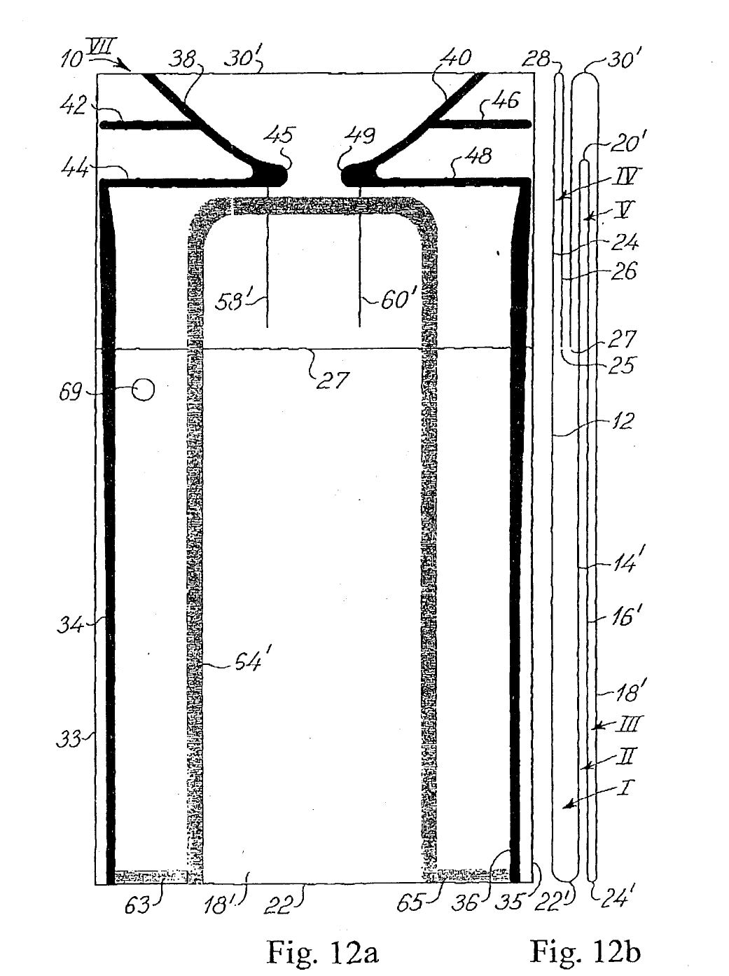

FIGS. 12a and 12b are schematic elevational and side-sectional views, respectively, of the seventh embodiment of the inflatable bag according to the present invention, AND

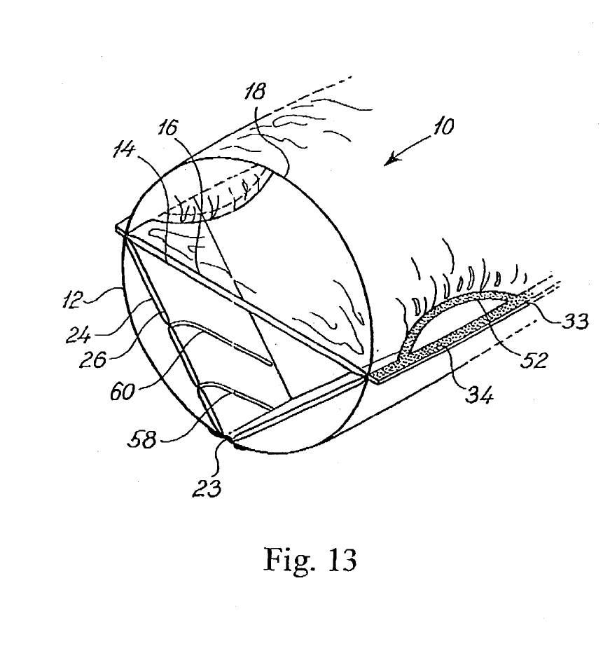

FIG. 13 is a schematic view illustrating a particular detail of the self-closure valve of the first, second, sixth and seventh embodiments of the inflatable bag according to the second aspect of the present invention and produced in accordance with the method according to the first aspect of the present invention illustrated in FIGS. 6a, 6b, FIGS. 7a, 7b, FIGS. 11a, 11b and FIGS. 12a, 12b, respectively.

The present invention relates to a novel technique of packaging and protecting an object by means of an inflatable bag. In FIGS. 1 and 2, an inflatable bag designated the reference numeral 10 in its entirety is shown, which bag is to be described in greater details below the reference to FIGS. 6a and 6b.

Generally, the bag 10 includes an inner chamber sandwiched between two outer chambers which are communicating with one another and are inflatable through the application of an inflation medium, such as atmospheric air, pressurized air or a non-toxic liquid, such as water into the two mutually communicating outer chambers. Preferably, the inflation medium is constituted by a gas, such as atmospheric air or alternatively a non-aggressive or substantially inert or truly inert gas such as nitrogen or alternatively helium.

In FIGS. 1 and 2, the technique of utilizing the bag 10 according to the second aspect of the present invention and produced in accordance with the method according to the first aspect of the present invention, is shown, however, before describing the use of the bag for the intentional packaging and protecting purpose as illustrated in FIG. 1, the bag 10 is to be described in greater details with reference to FIGS. 6a and 6b.

In FIG. 6a, the bag 10 is shown in a plane and elevational view and in FIG. 6b, in a vertical sectional view. The bag 10 is basically made from a single foil material web, such as an HDPE, MDPE or LDPE foil, e.g. of a thickness of 10-100 μm, such as 15, 25μ or 50μm. The web is folded into a four-layer structure defining an outer wall 12, two inner walls 14 and 16 and an outer wall 18. The inner walls 14 and 16 are joined together through a bottom fold 20 and similarly, the outer walls 12 and 18 are joined together through a bottom fold 22. The inner wall 16 and the outer wall 18 are further joined through a top fold 32. Between the outer wall 12 and the inner wall 14, a first chamber I is defined and between the inner walls 14 and 16, a second chamber II is defined constituting an inner chamber. Between the inner wall 16 and the outer wall 18, a further chamber III is defined. The chambers 1 and 3 communicate with one another through a passage between the bottom folds 20 and 22.

The outer wall 12 and the inner wall 14 are provided with extensions or prolongations or extensions 24, 26 defining turned-in parts extending into the interior of the chamber 1, as the prolongations or extensions 24 and 26 are folded from the outer wall 12 and the inner wall 14, respectively through folds 28 and 30, respectively. Between the top part of the outer wall 12 and the turned-in prolongation 24 thereof, a closure pocket or closure chamber IV is defined and similarly, between the inner wall 14 and the turned-in prolongation 26 thereof, a closure chamber or closure pocket V is defined. In FIGS. 6a and 6b, the lower ends of the turned-in prolongations or extensions 24 and 26 are designated the reference numerals 25 and 27, respectively.

As is evident from FIG. 6a, the four layers or walls 12, 14 ,16 and 18 of the bag 10 are joined together through a plurality of joints which may be constituted by glued joints or advantageously weld seams. Two major weld seams 34 and 36 extend parallel with outer edges 33 and 35 of the four-ply assembly extending from the bottom fold 22 to a position above the fold 32. From the position above the fold 32, two additional weld seams 44 and 48 extend inwardly defining an inlet passage into the interior of the bag, i.e. into the inner chamber I at inner weld seam ends 45 and 49 and further through the passage between the bottom folds 20 and 22 into the inner chamber III. From the weld seam ends 45 and 49, two outwardly diverging weld seams 38 and 40, respectively, extend upwardly to the upper folds 28 and 30 and at a position approximately at the centre of the outwardly diverging weld seams 38 and 40, two outwardly extending transversal weld seams 42 and 46 extend to positions closely adjacent the outer edges 33 and 35, respectively.

The bag 10 is, as will be described in greater details below with reference to FIGS. 1-3, provided with a self-closure established by the above-described turned-in prolongations or extensions 24 and 26 defining the closure chambers or closure pockets IV and V and further two additional weld seams 58 and 60 which join the two turned-in prolongations or extensions 24 and 26 together, defining an inlet channel extending from the opening defined between the weld seam ends 45 and 49 into the inner chambers I and III of the bag 10. The weld seams 58 and 60 are advantageously configurated in the shapes illustrated in FIG. 6a, each constituted by two linear weld seam segments interconnected through an arch. For providing a safe and reliable closure of the bag after the bag has been filled with the inflation medium such as air as will be described, a further weld seam 23 is provided.

The weld seam 23 join, different from the weld seams 58 and 60 joining the two turned-in prolongations or extensions 24 and 26 together and different from weld seams 34, 36, 38, 40, 42, 44, 46 and 48 joining the walls 12, 14, 16 and 18 or the outer walls 12 and 18 together the two turned-in prolongations or extensions 24 and 26 to the outer wall 12. Alternatively, the weld seam 23 might as well be established linking the two turned-in prolongations or extensions 24 and 26 to the inner wall 14. Characteristic of the weld seam 23 is, at any rate, the fact that the weld seam joins the turned-in prolongations or extensions 24 and 26 to one of the two walls defining the inner chamber I into which the turned-in prolongations or extensions 24 and 26 extend.

The weld seam 23 serves the purpose as will also be discussed in greater details below of stretching the two foil layers constituting the turned-in prolongations or extensions 24 and 26 after the inner chambers I and III and also the closure chambers IV and V have been filled with air and stretching the material of the foils between the two weld seams 58 and 60 defining the inlet channel, thereby preventing any air from escaping through the inlet channel defined between the two weld seams 58 and 60. As shown in FIG. 6a, a single weld seam 23 is provided, alternatively, a set of weld seams each similar to the weld seam 23 may be provided.

The bag 10 shown in FIG. 6a further includes additional weld seams 50, 52, 54 and 56 delimiting the width of the inner chamber II of the bag and a further weld seam 52 positioned opposite the closure and inlet of the bag at a position somewhat above the bottom fold 22 for delimiting the height of the inner chamber II of the bag. The purpose of the additional weld seams 50, 52, 54, 56 and 62 will be evident from the description of the use of the bag as is illustrated in FIGS. 1 and 2.

In FIG. 1, the bag 10 is shown in a non-inflated state having the wall 18 facing upwards. For receiving, packaging and protecting an object, such as a mobile phone 70 within the bag, the mobile phone 70 is introduced into the inner chamber II of the bag through the opening defined between the fold 32 and the inner wall 14. In FIG. 1, the mobile phone 70 is illustrated in a position in which the mobile phone is partly introduced into the inner chamber II. The mobile phone 70 in itself includes a housing 72 having a top surface 74 on which a plurality of keys 76 of a keyboard is provided and on which a display 78 is further provided. After the mobile phone 70 has been introduced into the interior of the bag, i.e. into the chamber II of the bag, the mobile phone is kept in its intentional position at the centre of the bag by the additional weld seams 50, 52, 54, 56 and 62 as the mobile phone 70 is prevented from being shifted to a position close to the outer weld seams 34 and 36 and further close to the bottom fold 22. As the mobile phone is maintained in its central position within the inner chamber II, the bag is inflated by means of a pressurized air source or by simply blowing air into the chambers I and III communicating through the passage between the folds 20 and 22, thereby inflating the chambers I and III and at the same time filling out the closure pockets or closure chambers IV and V providing the self-closure sealing-off the inner chambers I and II. The pressurized or inflated state of the bag I is illustrated in FIG. 2, which also illustrates the proper positioning of the object being the mobile phone 70 at the central position within the non-inflated inner chamber II of the bag 10.

In FIG. 3, the bag 10 is illustrated in its inflated state as viewed from the bottom side as the wall 12 of the bag 10 faces upwardly. In FIG. 3, the self-closure valve is illustrated in greater details as the dot-shaped joint 23 is shown providing the tensioning and stretching of the foil material of the turned-in prolongations or extensions 24 and 26 and thereby stretching the foil material within the inlet channel defined between the two weld seams 58 and 60.

In FIGS. 4 and 5, details of a method of producing the bag 10 is illustrated. In FIG. 5, the reference numerals 1, 2, 3, 4, 5 and 6 represent 6 distinct stages of producing the bag.

In the stage 1, a two-ply web is provided, comprising two layers 11 and 13, connected through the fold 32.

In stage 2, the turned-in prolongations or extensions 24 and 26 are provided by folding turned-in parts of the layers 11 and 13 towards the fold 32.

In stage 3, the two-ply structure is further folded for providing the folds 20 and 22, thereby providing the complete four-ply structure including the four layers or walls 12, 14, 16 and 18 and the turned-in prolongations or extensions 24 and 26. In stage 3, the parallel weld seams 58 and 60 are further provided by means of a welding tool designated the reference numeral 100 in its entirety, which tool is to be described in greater details with reference to FIG. 4.

In stage 4, a separation element 102 is positioned between the turned-in protrusion 26 and the adjacent inner wall 14 for allowing the dot-shaped weld seam 23 to be established by the application of heat to the three-ply structure including the wall 12 and the two turned-in protrusions 24 and 26.

In stage 5, the weld seams 34, 36, 38, 40, 42, 44, 46, 48, 50, 52, 54, 56 and 62 are established by means of sandwiching welding tools 110 and 112 which welding tools are preferably operated in a reciprocating operational mode allowing the individual bags 10 to be welded one at a time, e.g. in accordance with a technique described in the applicants published international patent application WO99/32840.

Finally, in stage 6, the finalised bag 10 is cut from the continuous previously processed web by means of a vertically operated and reciprocating knife 114 which web has been shifted through the stages 1, 2, 3, 4 and 5.

In FIG. 4, the separation and welding tools used in the stages 3 and 4 are illustrated in greater details. The tool 100 for the welding of the inlet channel delimiting weld seams 58 and 60 is constituted by a substantially L-shaped insulating element 102, 105, 107 and 104 which is provided with two printed circuit board connections which are connected to an external power source through two electric wires 106 and 108, respectively. The L-shaped insulating element 104 is provided with an enlarged end-part 116 from which two resistor wires having the configuration of the weld seams 58 and 60 are depending from the lower side. The wires are designated the reference numerals 118 and 120 and are interconnected through a short-circuiting printed circuit board connection 122.

As will be understood, the printed circuit board connections 105 and 107 together with the short-circuiting printed circuit board connection 122 provide a series connection of the two resistor wires 118 and 120 which are powered by the external electric power source connected to the wires 106 and 108. The plate 116 is pressed into contact with the turned-in prolongations or extensions 24 and 26 by the application of pressure from above by means of a pressure plate 122, which is journaled on two linear guides 126 and 128 and which is caused to reciprocate vertically by means of a piston 130. At the lower side of the plate 122, a soft surface padding is provided.

Opposite the vertically reciprocating plate 122, a separation plate 132 is provided, which separation plate is positioned between the turned-in prolongation 24 and the outer wall 12. It is to be realized that the plate 116 separates the turned-in prolongations or extensions 26 from the inner wall 14 preventing the inner wall 14 from being welded to the turned-in prolongation 26 as the separation plate 132 similarly prevents the turned-in prolongations or extensions 24 from being welded to the outer wall 12.

Below the separation plate 132, a plate 134 of the frame of the apparatus is positioned.

From an edge part of the plate 116 opposite to the I-shaped insulating element 104, a teflon band 103 extends, which teflon band is also shown in FIG. 4 serving the purpose of separating the wall 14 from the turned-in prolongation 26. The separation element 102 further serves the purpose of separating the wall 14 from the wall 16 for preventing the foil materials of the walls 14, 16 and 18 from being welded together as heat is applied from below 4 to the outer surface of the wall 12 by means of a heating tool 12 for providing the dot-shaped weld seam 23 causing the turned-in prolongation 24 and 26 to be welded to the wall 12.

In FIGS. 7a, 7b, FIGS. 8a, 8b, FIGS. 9a, 9b, FIGS. 10a, 10b, FIGS. 11a, 11b and FIGS. 12a, 12b, a second, a third, a fourth, a fifth, a sixth, and a seventh embodiment, respectively, of the bag according to the second aspect of the present invention and produced in accordance with the method according to the first aspect of the present invention is shown. In the below description of these alternative embodiments, no detailed description of the previously described elements is presented as elements previously described in the above description of the first and presently preferred embodiment and also present in the embodiments to be described are designated the same reference numerals. Elements in the below discussed embodiments having functions similar to functions of elements described above, however geometrically differing from the above-described elements are designated the same integer, however added a marking for identifying the difference and are identified below. Elements not present in the previously described embodiments or completely different from elements previously described are designated reference numerals not used previously and are to be discussed in greater details below.

In FIGS. 7a and 7b, a second embodiment is shown differing from the above-described first and presently preferred embodiment in that the embodiment is a single-chamber embodiment. The second embodiment is in its entirety designated the reference numeral 10′ and as stated, differs from the above-described first embodiment in that the inner walls 14 and 16 are omitted and the outer wall 18′ is connected through the fold 30 to the turned-in prolongation 26′.

In FIGS. 7c and 7d, a modified version of the second embodiment 10′ shown in FIG. 7a and 7b is illustrated designated the reference numerals 10″ in its entirety. The modified second embodiment 10″ basically differs from the above-described second embodiment 10′ in that the inner chamber of the modified second embodiment is divided into a plurality of individual sub-sections or compartments and as the modified second embodiment consequently constitutes a compartmentalized bag. The compartmentalizing of the bag is established through horizontal and vertical weld seams 140 and 142, respectively, dividing the inner chamber of the modified, compartmentalized second embodiment 10″ in a number, such as 25, identical compartments having a base surface of a square. The compartmentalized bag need not to be of a square configuration and may alternatively have a substantially rectangular elongated configuration including a number of individual compartments differing from 25. Examples of compartmentalized bags include any arbitrary number between 2 and e.g. 100, such as 9, 16, 36 or 12, 18, 28 individual compartments.

The non-compartmentalized second embodiment 10′ shown in FIGS. 7a and 7b and the modified, compartmentalized second embodiment 10″ shown in FIGS. 7c and 7d are intended to be used for wrapping products to be protected into the bag after inflation of the bag or alternatively as separation or protecting layers within a package. In FIG. 7e, the usage of the modified, compartmentalized second embodiment 10″ is shown as three inflated compartmentalized bags 10″ are positioned within a container or package 150 separating a number of individual objects, such as an electronic apparatus from impact from the outside as the individual apparatuses designated the reference numeral 144 are arranged in two layers separated by the three compartmentalized packaging bags 10″.

In FIGS. 8a, a third embodiment of the bag according to the second aspect of the present invention and produced in accordance with the method according to the first aspect of the present invention is shown, which bag is an inflatable three-chamber bag similar to the above-described first and presently preferred embodiment of the bag 10. The third embodiment of the bag shown in FIGS. 8a and 8b is designated the reference numeral 10^{III}, in its entirety. The bag 10′″basically differs from the above-described first and presently preferred embodiment in that the inlet channel-defining weld seams 58 and 60 are omitted and substituted by linear weld seams 58′ and 60′ and as the dot-shaped weld seam 23 positioned outside the inlet channel delimited between the weld seams 58 and 60 is substituted by a dot-shaped weld seam 23′ joining the one turned-in elongation 24 to the outer wall 12 for providing the stretching of the foil materials of the turned-in elongations 24 and 26 as the bag is inflated for ensuring the proper sealing-off and closure of the bag.

In FIGS. 9a and 9b, a fourth embodiment of the bag according to the second aspect of the present invention and produced in accordance with the method according to the first aspect of the present invention is shown, basically differing from the above-described first and third embodiments of the bag according to the second aspect of the present invention and produced in accordance with the method according to the first aspect of the present invention shown in FIGS. 1-3, 6a, 6b and FIGS. 8a, 8b, respectively, in that the inner chamber is openable from the bottom end as the outer wall 12 is connected to the inner wall 14′ through a bottom fold 22′, and the inner wall 16′ is connected to the outer wall 18′ through a bottom fold 32′. Similarly, the inner walls 14′ and 16′ are connected to one another through a top fold 20′ and the turned-in protrusion 26′ is connected to the outer wall 18′ through a top fold 30′ positioned juxtaposed the fold 18 connecting the turned-in protrusion 24 to the outer wall 12. Further, as is evident from FIG. 9a, the inlet channel is defined by the weld seams 58′ and 60′ shown in FIGS. 8a and 8b, whereas the dot-shaped weld seam 23′ shown in FIGS. 8a and 8b is omitted.

In FIGS. 10a and 10b, a fifth embodiment of the bag according to the second aspect of the present invention and produced in accordance with the method according to the first aspect of the present invention is shown differing from the above-described first and presently preferred embodiment of the bag 10 illustrated in FIGS. 1-3 and 6a, 6b. The fifth embodiment 10^{IV} differs from the above-described first embodiment 10 in that the inlet channel-defining weld seams 58 and 60 are omitted and in that the dot-shaped weld seam 23 is also omitted. Instead, a total of four weld seams 58″, 59, 60″ and 61 are provided defining an inlet channel in the form of a labyrinth. Like the above-described third embodiment 10^{III} shown in FIGS. 8a and 8b, the fifth embodiment 10^{IV} is further provided with a weld seam 23″ joining the turned-in prolongation 24 to the outer wall 12. The weld seam 23″ is basically of a linear configuration and is positioned in a transversal or horizontal orientation as compared to the vertical or longitudinal direction of the bag.

In FIGS. 11a and 11b, a sixth embodiment of the bag is shown designated the reference numeral 10^{VI} in its entirety. The sixth embodiment 10^{VI} basically constitutes a modified version of the above-described first and presently preferred embodiment 10 shown in FIGS. 1-3 and 6a, 6b, as the weld seams 50, 52, 54, 56 and 62 are omitted and substituted by a U-configurated weld seam 64 delimiting the inner chamber II of the bag into a configuration for receiving the object to be protected and packaged within the bag, such as a mobile telephone 70, still providing circumferential parts of the first and second chamber I and II, respectively, encircling sideways and at the bottom the inner chamber II delimited by the U-shaped weld seam 64.

In FIGS. 12a and 12b, a seventh embodiment of the bag according to the present invention is shown designated the reference numeral 10^{VII}. The seventh embodiment 10^{VII} constitutes a combination of the above-described fourth and sixth embodiment 10^{IV} and 10^{VI}, respectively, shown in FIGS. 9a, 9b and FIGS. 11a, 11b, respectively, as the fourth embodiment 10^{IV} shown in FIG. 9a is provided with the inner chamber delimiting U-shaped weld seam 64′ turned upside down as compared to the U-shaped weld seam 64 shown in FIG. 11a. The U-shaped weld seam 64′ shown in FIG. 12a is further connected to the weld seams 34 and 36 through bottom weld seams 63 and 65, respectively. In the seventh embodiment, an aperture 69 is further provided in the inner walls 14′ and 16′ for establishing direct connection between the circumferential chambers defined between the outer vertical weld seams 34 and 36 and the U-shaped weld seam 64′.

In FIG. 13, a detail of the closure of the first and presently preferred embodiment of the bag shown in FIGS. 1-3 and 6a, 6b is shown illustrating the stretching of the turned-in prolongation layers after the inflation of the bag. In FIG. 13, a horizontal sectional view through the dot-shaped weld seam 23 is shown illustrating the stretching of the turned-in prolongations or extensions 24 and 26 as compared to the inner walls 14 and 16. As is evident from FIG. 13, the outer walls are stretched into a curved configuration and through the provision of the dot-shaped weld seam 23, the turned-in prolongations or extensions 24 and 26 are, in the triangular configuration shown in FIG. 13, stretched as compared to the inner walls 14 and 16, thereby pressing the foil layers delimited between the inlet channel-defining weld seams 58 and 60 together, preventing leakage of gas from within the inner chamber through the inlet channel.

### EXAMPLE 1

A prototype version of the first and presently preferred embodiment of the bag 10 according to the second aspect of the present invention and produced in accordance with the method according to the first aspect of the present invention was made from 35 μm LDPE. The outer wall 12 measured 275 mm×150 mm and the outer wall 18 measured 235 mm×150 mm. The turned-in prolongations or extensions 24 and 26 defined a length from the upper edges 28 and 30 of 95 mm. A total of 1000 bags were tested for 2-30 days and all bags turned out to ensure a proper elevated gas pressure within the inner chambers I and III for the period of time of testing.

Although the present invention has been ascribed above the reference to specific embodiments of the bag and also specific embodiments of the closure, it is of course to be contemplated that numerous modifications be deduced by a person having ordinary skill in the art and modifications readily perceivable by a person having ordinary skill in the art is consequently to be construed part of the present invention as defined in the appending claims.

1. A method of producing an inflatable bag for packaging and protecting an object received within the bag, comprising:
i) providing a continuous band of a foil material,
ii) moving said band in the longitudinal direction of the band,
iii) folding said band parallel to the longitudinal direction of the band into a four-ply assembly defining four foil layers of substantially identical shape,
iv) joining a first and a second foil layer of said assembly to one another by a first set of joints extending substantially transversely relative to the longitudinal direction of said band,
v) joining said second foil layer and a third foil layer of said assembly being interconnected through a first fold by a second set of joints extending substantially transversely relative to the longitudinal direction of said band,
vi) joining said third foil layer and a fourth foil layer of said assembly to one another by a third set of joints extending substantially transversely relative to the longitudinal direction of said band,
vii) separating a segment of said four-ply assembly delimited by said sets of joints, thereby providing said inflatable bag having a first chamber defined between said first and second foil layers, a second chamber defined between said second and third foil layer and a third chamber defined between said third and fourth foil layer, said bag further having an inner chamber constituted by said second chamber, and communicating with the environment through a first opening opposite said first fold for allowing the object to be introduced into the inner chamber through the first opening, and said first and third chambers communicating with one another through a passage delimited by said first fold and a second fold interconnecting said first foil layer and said first or second foil layer and further communicating with the environment through a closable and sealable second opening for allowing an inflation medium to be introduced into said first and third chamber through said closable and sealable, second opening.

2. The method according to claim 1, said sets of joints being established by welding, through the application of an adhesive or a glue or in a combination of a welding and adhesive application/gluing application technique.

3. The method according to any of claims 1 or 2 further comprising the step of providing prolongations of said fourth foil layer and said first or said second foil layer, said prolongations defining turned-in parts extending into said first or third chamber and being joint together for providing two closure pockets for establishing a self-closure valve at said closable and sealable, second opening.

4. The method according to claim 3, said step of providing prolongations of said fourth foil layer and said first or said second foil layer further comprising the step of joining said prolongations together by additional joints for permanently maintaining said turned-in parts of said prolongations of said prolongations in a face-to-face and non-folded state.

5. The method according to any of the claims 1 or 2, further comprising the step of providing prolongations of said fourth foil and said first or said second foil layer, and the step of providing perforations or cuttings defining flaps of said prolongations for allowing said flaps to be tight together providing a closure knot for closing of said closable and sealable, second opening.

6. The method according to any of the claims 1-5, said continuous foil material band being constituted by an integral continuous web of a single layer or a multilayer plastics material substantially impermeable to liquid and/or gas, or alternatively said continuous foil material band being composed of two, three or four foil layer sheets of the same or different plastics materials constituting respective foil layers of said bag and made from the same or different plastics materials substantially impermeable to liquid and/or gas.

7. The method according to any of the claims 1-6, said steps iv) and vi) being performed so as to produce said first set of joints being coextensive with and joint to said third set of joints.

8. The method according to any of the claims 1-7, said steps v) and iv) and/or vi) being performed so as to produce said second set of joints being coextensive with and joint to said first and/or said third set of joints.

9. The method according to any of the claims 1-8, further comprising the steps of delimiting by said second chamber further joints interconnecting said second and third foil layers and/or being separated into two or more separate chambers or compartments.

10. The method according to any of the claims 1-9, further comprising the step of producing perforations or holes in said second and third foil layers for interconnecting said first and third chambers.

11. An inflatable bag for packaging and protecting an object received within said bag and produced in accordance with the method according to claim 1, comprising:
a web of a foil material, said web defining an elongated configuration having a first set of opposite parallel edges,
said web being folded into a four-ply assembly folded transversely relative to said edges and defining four foil layers of substantially identical shape,
a first and a second foil layer of said assembly being joint to one another by a first set of joints extending substantially parallel with said edges and defining a first chamber,
said second foil layer and a third foil layer of said assembly being interconnected through a first fold and joint to one another by a second set of joints extending substantially parallel with said edges and defining a second chamber,
said third foil layer and a fourth foil layer of said assembly being joint to one another by a third set of joints extending substantially parallel with said edges and defining a third chamber,
said second chamber constituting an inner chamber communicating with the environment through a first opening opposite said first fold for allowing said object to be introduced into said inner chamber through said first opening, and
said first and third chambers communicating with one another through a passage delimited by said first fold and a second fold interconnecting said fourth foil layer and said first or said second foil layer and further communicating with the environment through a closable and sealable, second opening for allowing an inflation medium to be introduced into said first and third chambers through said closable and sealable, second opening.

12. The inflatable bag according to claim 11, said web being constituted by an integral continuous web of a plastics material substantially impermeable to liquid and/or gas, or alternatively said web being composed of two, three or four foil layer sheets constituting respective foil layer or layers of said web and made from a plastics material substantially impermeable to liquid and/or gas.

13. The inflatable bag according to any of the claims 11 or 12, said closable and sealable, second opening being constituted by prolongations or extensions of said fourth foil layer and said first or said second foil layer, said prolongations defining turned-in parts extending into said first or third chamber and being joint together for providing two closure pockets for establishing a self-closure valve at said closable and sealable, second opening.

14. The inflatable bag according to claim 13, said turned-in parts of said prolongations further being joint together by additional joints for permanently maintaining said turned-in parts of said prolongations in a face-to-face and non-folded state.

15. The inflatable bag according to any of the claims 11 or 12, said fourth foil layer and said first or said second foil layer defining prolongations provided with perforations or cuttings defining flaps of said prolongations for allowing said flaps to be tied together for providing a closure knot for closing off said closable and sealable, second opening.

16. The inflatable bag according to any of the claims 11-15, said first set of joints being coextensive with and joint to said third set of joints.

17. The inflatable bag according to any of the claims 11-16, said second set of joints being coextensive with and joint to said first and/or said third set of joints.

18. The inflatable bag according to any of the claims 11-17, said second chamber being delimited by further joints interconnecting said second and third foil layers and/or being separated into two or more separate chambers or compartments.

19. The inflatable bag according to any of the claims 11-18, said first and third chambers further being interconnected through perforations or holes in said second and third foil layers.

20. The inflatable bag according to any of the claims 11-19, said joints being welded joints or joints being established by means of a glue or an adhesive material or a combination thereof.

21. The inflatable bag according to any of the claims 11-20, said foil material of said web being polyethylene, preferably LDPE or HDPE or any other glueable or weldable foil material, preferably plastics or polymer foil material or aluminium foil material or combinations of such foil materials.

22. The inflatable bag according to any of the claims 11-21, said web defining additional sets of foil layers, each of said additional set of foil layers defining an additional inner chamber.

23. The inflatable bag according to any of the claims 11-22, said foil layers having rectangular configuration.

24. A closure of an inflatable bag, comprising:
two foil layers of substantial identical shape and constituting at least part of a pair of walls of said bag, said bag defining an inner space delimited by said pair of walls being joint together by a peripheral joint except for a peripheral area constituting an inlet opening including said closure,
said foil layers having at said inlet opening foil prolongations defining turned-in parts extending from said inlet opening into said inner space of said bag and defining from said inlet opening a longitudinal extension of said turned-in flaps into said inner space, said turned-in parts defining two closure pockets being open towards said inner space of said bag,
a first set of joints extending from said peripheral joint at said inlet transversely to said longitudinal direction, said first set of joints joining said foil layers and said prolongations together at a position along said longitudinal extension, said first set of joints defining a pair of opposite joint ends delimiting the width of said inlet opening,
a second set of joints joining said prolongations defining said turned-in parts together and extending from said joint ends towards said inner space of said bag, said second set of joints defining an inlet channel extending from said inlet opening into said inner space of said bag, and
at least one further dot-shaped joint joining said turned-in parts to one of said foil layers for maintaining said turned-in parts in parallel and stretched relationship when said closure pockets are filled with an inflation medium and pressurized as said bag be inflated.

25. The closure according to claim 24, said two foil layers constituting two separate foil layers of said bag or alternatively constituting integral parts of said pair of walls of said bag, said bag being a bag having a single inner chamber, a bag having two or more inner chambers defined by separate partition walls constituted by separate foil layers or constituted by folded foil parts of said walls of said bag.

26. The closure according to any of the claims 24 or 25, said first set of joints having joint extensions extending outwardly from said joint ends and defining a converging, diverging or straight extension of said inlet channel.

27. The closure according to any of the claims 24-26, said second set of joints being constituted by linear joints, curved joints, combined linear, bend and/or curved joints, and defining a diverging, converging or tubular inlet channel or a combined diverging, converging and/or straight inlet channel.

28. The closure according to any other claims 24-27, said dot-shaped joint being configurated as a circular, an eliptical, a square, a rectangular, a polygonal or any other configurated joint or a combination of any of the above joints or being composed of a plurality of individual microjoints.

29. The closure according to any of the claims 24-28, said prolongations being constituted by integral parts of said two foil layers or being constituted by separate foil layer parts joined to said two foil layers.

30. The closure according to any of the claims 24-29, said closure constituting a closure of an inflatable bag being produced in accordance with the method according to any of the claims 1-10 and having any of the features of the inflatable bag according to any of the claims 11-23.
